(19) United States
(12) Patent Application Publication
(10) Pub. No.: US 2019/0264019 A1
(43) Pub. Date: Aug. 29, 2019

(54) PRODUCTION OF A POLYMER EMULSION

(71) Applicant: COATEX, Genay (FR)

(72) Inventors: Clementine CHAMPAGNE, Caluire-et-Cuire (FR); Jean-Marc SUAU, Lucenay (FR)

(73) Assignee: COATEX, Genay (FR)

(21) Appl. No.: 16/340,849

(22) PCT Filed: Oct. 20, 2017
(86) PCT No.: PCT/FR2017/052883

§ 371 Date: Apr. 10, 2019

(30) Foreign Application Priority Data
Oct. 25, 2016 (FR) 1660345

(51) Int. Cl. C08L 33/02

(52) U.S. Cl. CPC C08L 33/02; C08L 2201/52

(57) ABSTRACT

The invention relates to a method for producing a polymer in water, comprising the preparation of an emulsion comprising a HASE-type copolymer and a mixture of a monomer comprising at least one polymerisable olefinic unsaturation and a radical-generating compound, followed by the polymerisation of the emulsified monomer by heating to a temperature higher than the temperature required for the polymerisation reaction. The invention also relates to the polymer produced in this way and to the use thereof.

The invention relates to a method for the preparation in water of a polymer, comprising the preparation of an emulsion comprising a copolymer of HASE type and a mixture of a monomer comprising at least one polymerizable olefinic unsaturation and of a radical-generating compound, followed by the polymerization of the emulsified monomer by heating at a temperature greater than the temperature required for the polymerization reaction. The invention also relates to the polymer prepared and to its use.

Although there exist methods for the preparation of polymers in water, the methods of the state of the art do not always make it possible to provide a satisfactory solution to the problems encountered.

In particular, the methods of the state of the art for the preparation of polymers in emulsion require the use of large amounts of surface-active compounds.

Furthermore, the known methods do not always make it possible to control the size of the emulsified monomer particles or the size of the particles of monomer which is prepared.

The methods for the preparation of polymers in an aqueous medium of the state of the art do not always make it possible to result in high levels of solids content.

There thus exists a need to have available improved methods for the preparation of polymers in water.

The method according to the invention makes it possible to provide a solution to all or some of the problems of the methods of the state of the art.

Thus, the invention provides a method for the preparation in water of a polymer (P1) comprising:
(a) the preparation, at a temperature of less than 40° C., of a mixture comprising water and at least one copolymer (P2) of HASE type completely or partially neutralized by means of a base,
(b) the addition, with stirring and at a temperature of less than 40° C.:
   (b1) of at least one monomer comprising at least one polymerizable olefinic unsaturation and
   (b2) of at least one radical-generating compound and
(c) the polymerization, with stirring, of the monomer (b1) by heating at a temperature of greater than 50° C.

Advantageously, the method according to the invention can be used with reduced or very reduced amounts of surface-active compound (less than 5% by weight of monomer, preferably less than 3% by weight or less than 1% by weight of monomer), indeed even in the absence of surface-active compound.

During the implementation of steps (a) and (b) of the method according to the invention, droplets of monomer (b1) are dispersed by means of the copolymer (P2) of HASE type. During the polymerization (c), the droplets of polymer (P1) are also dispersed by means of the copolymer (P2).

Particularly advantageously, the droplets formed during the implementation of the method according to the invention have a controlled size. Preferably, the droplets of monomer (b1) or of polymer (P1) have a size ranging from 50 nm to 50 μm, more preferably from 50 nm to 500 nm or from 1 μm to 50 μm. The size of the droplets of monomer (b1) or of polymer (P1) can also range from 50 nm to 1 μm or from 500 nm to 50 μm.

For the method according to the invention, the emulsion of monomer (b1) or of polymer (P1) which is prepared by means of the copolymer (P2) of HASE type has a solids content which can vary fairly widely. Preferably, this solids content ranges from 10% by weight to 50% by weight, preferably from 15% by weight to 45% by weight or from 20% by weight to 40% by weight of emulsion.

The copolymer (P2) used by the method according to the invention may generally be known as such. This copolymer (P2) is a polymer of HASE (Hydrophobically modified Alkali-Soluble Emulsion) type which is rendered soluble by a basic treatment. It is a linear or cross-linked acrylic copolymer comprising acid groups and hydrophobic groups. Such a copolymer of HASE type results from the copolymerization of anionic monomers, such as acrylic or methacrylic acids, of hydrophobic non-ionic monomers and of hydrophobic associative macromonomers. At low pH, generally of less than 5, and without the addition of a base, the acrylic copolymer of HASE type is insoluble in water and is present in the form of a latex. During the addition of a base, the anionic groups are partially or completely neutralized and the copolymer dissolves in the water.

Preferably, for the method according to the invention, the polymer (P2) of HASE type is obtained by a polymerization reaction:
(a1) of at least one anionic monomer comprising at least one polymerizable olefinic unsaturation, preferably an anionic monomer comprising at least one polymerizable olefinic unsaturation and at least one carboxylic acid group, preferably, the anionic monomer is chosen from acrylic acid and methacrylic acid, an acrylic acid salt, a methacrylic acid salt,
(a2) of at least one ester of a compound derived from an acid chosen from acrylic acid, methacrylic acid, itaconic acid and maleic acid, preferably acrylic acid or methacrylic acid, and
(a3) of at least one compound of formula (I):

R¹-(EO)ₘ—(PO)ₙ—R² (I)
in which:
   m and n, which are identical or different, independently represent 0 or an integer or decimal number of less than 150, m or n is other than 0,
   EO independently represents a CH₂CH₂O group,
   PO independently represents a group chosen from CH(CH₃)CH₂O and CH₂CH(CH₃)O,
   R¹ represents a linear or branched C₆-C₄₀ alkyl group, preferably a linear or branched C₈-C₂₀ alkyl group, and
   R² represents a group comprising at least one polymerizable olefinic unsaturation, preferably an acrylate group or a methacrylate group.

During the preparation of the polymer (P2), besides the comonomers (a1), (a2) and (a3), the polymerization reaction of the method according to the invention can use one or more other monomer(s).

Preferably, another monomer which can be used during the preparation of the polymer (P2) is a compound (a4) chosen from 2-acrylamido-2-methylpropanesulfonic acid, ethoxymethacrylate sulfonic acid, sodium methallylsulfonate, styrenesulfonate and their salts.

The amount of monomer (a4) can vary fairly widely. Preferably, the reaction for the preparation of the polymer (P2) uses from 0.1% by weight to 7% by weight, preferably from 0.5% by weight to 5% by weight, more preferably from 1% by weight to 3% by weight, of monomer (a4), based on the total amount by weight of monomer.

Preferably again, another monomer which can be used during the preparation of the polymer (P2) is a cross-linking compound (a5).

Advantageously, according to the invention, the monomer (a5) is a compound comprising at least two reactive functional groups, in particular two polymerizable olefinic unsaturations. The monomer (a5) is preferably chosen from monomers comprising at least two olefinic unsaturations. More preferably, the monomer (a5) is a compound comprising at least two ethylenic unsaturations. Such monomers (a5) are known as such.

Mention may be made, as monomers (a5), of cross-linking unsaturated monomers, for example polyunsaturated aromatic monomers, such as divinylbenzene, divinylnaphthalene and trivinylbenzene, polyunsaturated alicyclic monomers, for example 1,2,4-trivinylcyclohexane, difunctional esters of phthalic acid, such as diallyl phthalate, polyalkenyl ethers, such as triallyl pentaerythritol, diallyl pentaerythritol, diallyl sucrose, octaallyl sucrose and trimethylolpropane diallyl ether, polyunsaturated esters of polyalcohols or of polyacids, such as 1,6-hexanediol di(meth)acrylate, tetramethylene tri(meth)acrylate, allyl acrylate, diallyl itaconate, diallyl fumarate, diallyl maleate, trimethylolpropane tri(meth)acrylate, trimethylolpropane di(meth)acrylate, poly(alkyleneoxy) glycol di(meth)acrylates and polyethylene glycol di(meth)acrylate, alkylenebisacrylamides, such as methylenebisacrylamide and propylenebisacrylamide, hydroxy or carboxy derivatives of methylenebisacrylamide, such as N,N′-bis(methylol)methylenebisacrylamide, polyalkylene glycol di(meth)acrylates, such as ethylene glycol di(meth)acrylate, diethylene glycol di(meth)acrylate, triethylene glycol di(meth)acrylate, allyl methacrylate, ethylene glycol dimethacrylate, butylene glycol dimethacrylate, pentaerythritol di-, tri- and tetraacrylates, poly(alkyleneoxy) glycol di(meth)acrylates, such as polyethylene glycol diacrylates, bisphenol A diacrylates, butanediol dimethacrylate, 2,2-dimethylpropanediol dimethacrylate, phenylene diacrylate and their mixtures.

Mention may also be made, as monomer (a5), of a compound of formula (II):

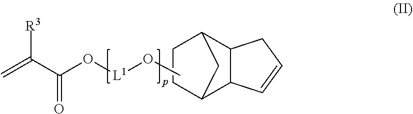

in which:
R³ independently represents H or CH₃,
L¹ independently represents a linear or branched C₁-C₂₀ alkylene group and
p independently represents 0 or an integer ranging from 1 to 30, for example from 1 to 20, especially from 1 to 15, in particular from 1 to 10.

Mention may also be made, as other monomer (a5), of a compound of formula (III):

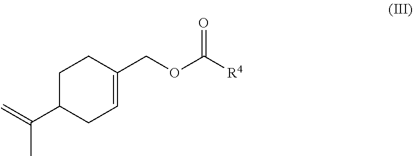

in which R⁴ represents —C(H)═CH₂, —C(CH₃)═CH₂, —C(H)═C(H)C(O)OH, —C(H)═C(H)CH₃, —C(═CH₂)CH₂C(O)OH, —CH₂C(═CH₂)C(O)OH.

Mention may again be made, as monomer (a5), of a compound of formula (IV):

H₂C═C(R⁵)CH₂—(OL²)_{q}-O—C(═O)R⁶ (IV)

in which:
R⁵ independently represents H or CH₃,
R⁶ independently represents —C(H)═CH₂, —C(CH₃)═CH₂, —C(H)═C(H)C(O)OH, —C(H)═C(H)CH₃, —C(═CH₂)CH₂C(O)OH, —CH₂C(═CH₂)C(O)OH,
L² independently represents an ethylene, propylene or butylene group and
q independently represents 0 or an integer or decimal number ranging from 1 to 30.

The amount of monomer (a5) can also vary fairly widely. Preferably, the reaction for the preparation of the polymer (P2) uses from 0.01% by weight to 5% by weight, preferably from 0.05% by weight to 3% by weight, more preferably from 0.05% by weight to 1% by weight, of monomer (a5), based on the total amount by weight of monomer.

Preferably, for the method according to the invention, the copolymer (P2) of HASE type is partially neutralized by means of a base, for example by means of an alkali metal derivative or of an alkaline earth metal derivative. The preferred bases are chosen from NaOH, KOH, NH₄OH, Ca(OH)₂, monoisopropylamine (AMP), triethylamine, diethylamine, monoethylamine.

The method according to the invention also comprises the addition, with stirring and at a temperature of less than 40° C., of at least one monomer (b1) comprising at least one polymerizable olefinic unsaturation and of at least one radical-generating compound (b2). Advantageously, according to the invention, the solubility in water of the monomer (b1) makes it possible to obtain an emulsion during the mixing with stirring in the copolymer (P2). Thus, a dispersion of nanometric droplets of monomer (b1) in water is formed. Preferably, for the method according to the invention, the monomer (b1) is a non-ionic monomer, preferably a non-ionic monomer comprising at least one polymerizable olefinic unsaturation, especially a polymerizable ethylenic unsaturation and in particular a polymerizable vinyl group.

More preferably, the monomer (b1) is a non-ionic monomer chosen from the esters of an acid comprising at least one monocarboxylic acid group, especially an ester of an acid chosen from acrylic acid, methacrylic acid, an acrylic acid salt, a methacrylic acid salt and their mixtures.

Preference is given, as examples of monomer (b1), to a compound chosen from styrene, vinylcaprolactam, alkyl acrylate, especially C₁-C₁₀ alkyl acrylate, preferably C₁-C₄ alkyl acrylate, more preferably methyl acrylate, ethyl acrylate, propyl acrylate, isobutyl acrylate, n-butyl acrylate, alkyl methacrylate, especially C₁-C₁₀ alkyl methacrylate, preferably

C₁-C₄ alkyl methacrylate, more preferably methyl methacrylate, ethyl methacrylate, propyl methacrylate, isobutyl methacrylate, n-butyl methacrylate, aryl acrylate, preferably benzyl acrylate, phenoxyethyl acrylate, aryl methacrylate, preferably phenyl methacrylate, benzyl methacrylate, phenoxyethyl methacrylate. The monomers (b1) which are particularly preferred are methyl acrylate, ethyl acrylate, propyl acrylate, isobutyl acrylate, n-butyl acrylate, methyl methacrylate, ethyl methacrylate, propyl methacrylate, isobutyl methacrylate and n-butyl methacrylate.

Step (b) according to the invention uses at least one radical-generating compound (b2). It can be soluble in water or else soluble in the organic phase, in particular in the monomer (b1).

Preferably, for the method according to the invention, the radical-generating compound (b2) of use as initiating compound for the polymerization reaction is an azo compound. More preferably, the radical-generating compound (b2) is a compound chosen from azobisisobutyronitrile (AZDN or AIBN), a peroxide compound, preferably benzoyl peroxide, benzoyl hydroperoxide and their mixtures. Mention may also be made of alkali metal persulfates, especially sodium persulfate and potassium persulfate, ammonium persulfate, partially water-soluble peroxides, especially persuccinic acid, t-butyl hydroperoxide, cumyl hydroperoxide, persulfates combined with a ferrous ion, with a sulfite ion or with a bisulfite ion, and their mixtures.

According to the invention, the radical-generating compound (b2) can be combined with at least one controlled radical polymerization transfer agent, in particular a transfer agent of RAFT (Reversible Addition-Fragmentation chain Transfer) type, for example a xanthate derivative, preferably dipropyl trithiocarbonate (DPTTC or disodium 2,2′-(thiocarbonylbisthio)dipropanoate—CAS No. 864970-33-2), n-dodecyl mercaptan. Preferably, during the implementation of the method according to the invention, the radical-generating compound (b2), preferably a hydrophobic radical-generating compound (b2), and the monomer (b1) are added in the form of a mixture.

Preferably again, during the implementation of the method according to the invention, the radical-generating compound (b2), preferably a hydrophilic radical-generating compound (b2), and the monomer (b1) are added separately or successively, preferably the radical-generating compound (b2) then being added after the monomer (b1).

During the polymerization reaction of the monomer (b1), besides the compounds (b1) and (b2), the polymerization reaction of the method according to the invention can use one or more other monomer(s).

Preferably, another monomer which can be used during the polymerization of the monomer (b1) is a monomer chosen from:
(b3) at least one non-ionic hydrophilic monomer, for example vinyllactams, such as N-vinylpyrrolidone, hydroxypropyl acrylates, C₁-C₅ hydroxyalkyl acrylate, C₁-C₅ hydroxyalkyl methacrylate, acrylamides, methacrylamides, diacetone acrylamide, N-isopropylacrylamide,
(b4) at least one anionic monomer, preferably an anionic monomer comprising at least one polymerizable olefinic unsaturation, especially a polymerizable ethylenic unsaturation and in particular a polymerizable vinyl group, and at least one carboxylic acid group, preferably a monomer chosen from acrylic acid, methacrylic acid, maleic acid, itaconic acid, crotonic acid, an acrylic acid salt, a methacrylic acid salt, a maleic acid salt, an itaconic acid salt, a crotonic acid salt, (b5) at least one compound chosen from 2-acrylamido-2-methylpropanesulfonic acid, ethoxymethacrylate sulfonic acid, sodium methallylsulfonate, styrenesulfonate and their salts and
(b6) at least one monomer comprising at least two olefinic unsaturations.

More preferably, according to the invention, the monomer (b3) is chosen from hydroxyethyl acrylate, hydroxyethyl methacrylate, hydroxypropyl acrylate, hydroxypropyl methacrylate, N-isopropylacrylamide.

More preferably, according to the invention, the monomer (b4) is methacrylic acid.

According to the invention, the amount by weight of monomer (b4) used is less than the amount by weight of monomer (b1).

The amount of monomer (b5) can vary fairly widely. Preferably, the reaction for the polymerization of the monomer (b1) can use from 0.1% by weight to 7% by weight, preferably from 0.5% by weight to 5% by weight, more preferably from 1% by weight to 3% by weight, of monomer (b5), based on the total amount by weight of monomer.

Preferably again, another monomer which can be used during the polymerization of the monomer (b1) is generally a cross-linking compound (b6).

Advantageously, according to the invention, the monomer (b6) is a compound comprising at least two reactive functional groups, in particular two polymerizable olefinic unsaturations. The monomer (b6) is preferably chosen from monomers comprising at least two olefinic unsaturations. More preferably, the monomer (b6) is a compound comprising at least two ethylenic unsaturations. Such monomers (b6) are known as such.

Mention may be made, as monomer (b6), of the monomers defined as specific monomers (a5) according to the invention.

The amount of monomer (b6) can also vary fairly widely. Preferably, the reaction for the polymerization of the monomer (b1) can use from 0.01% by weight to 5% by weight, preferably from 0.05% by weight to 3% by weight, more preferably from 0.05% by weight to 1% by weight, of monomer (b6), based on the total amount by weight of monomer.

For the method according to the invention, the temperature of steps (a) and (b) is less than 40° C. in order to prevent the polymerization of the monomer (b1). Advantageously, the temperature of steps (a) and (b), which is identical or different, can be less than 35° C. or be less than 25° C.

During the implementation of the method according to the invention, the heating of step (c) makes it possible to carry out the polymerization of the monomer (b1). Preferably, for the method according to the invention, the temperature of step (c) is greater than 60° C., preferably greater than 70° C.

When several monomers (b1) are used, this heating makes it possible to carry out the copolymerization of these monomers (b1). In the same way, when several monomers (b1) and (b3) to (b6) are used, this heating makes it possible to carry out the copolymerization of these monomers (b1) and (b3) to (b6).

The invention also relates to the polymer (P1) capable of being prepared according to the invention.

Advantageously, the method according to the invention can make it possible to prepare an emulsion within which the monomer (b1) is surrounded by the copolymer (P2) of HASE type. The droplets of monomer (b1) then constitute as many polymerization nanoreactors or microreactors. During the polymerization of the monomer (b1) emulsified in the form of droplets surrounded by copolymer (P2), the polymer (P1) formed can then also be in the form of droplets surrounded by copolymer (P2). A core/shell composite can thus be prepared during the implementation of the method according to the invention.

The invention thus also relates to a composite comprising at least one polymer (P1) prepared according to the invention surrounded by copolymer (P2) of HASE type used according to the invention. The specific, advantageous or preferred characteristics of the method according to the invention or of the polymer (P1) according to the invention define as many composites according to the invention which are specific, advantageous or preferred.

The examples which follow make it possible to illustrate the different aspects of the invention.

### EXAMPLES

### Example 1: Method for the Preparation of Polymers (P1) According to the Invention

A mixture of water, of copolymer (P2) of HASE type, of a base (95% by weight monoisopropylamine) and, if appropriate, of an amphiphilic compound (Disponil G625, Cognis) is prepared in a stirred reactor at a temperature of 25° C. The copolymers (P2) of HASE type used are:
copolymer (P2-1), for which (a1) is methacrylic acid (36.7% by weight), (a2) is ethyl acrylate (27% by weight), (a3) is a compound of formula (I) in which m represents 25, n represents 0, R¹ represents a branched C₁₆ alkyl group and R² represents a methacrylate group (9.2% by weight), prepared in the presence of n-dodecyl mercaptan (0.29% by dry/dry weight of the total amount of monomers), and
copolymer (P2-2), for which (a1) is methacrylic acid (40.9% by weight), (a2) is styrene (27% by weight), (a3) is a compound of formula (I) in which m represents 25, n represents 0, R¹ represents a branched C₁₆ alkyl group and R² represents a methacrylate group (9.2% by weight), prepared in the presence of n-dodecyl mercaptan (0.29% by dry/dry weight of the total amount of monomers).

A mixture of monomer (b1) and of radical-generating compound (b2) is added with stirring at a temperature of 25° C. in order to prepare an emulsion of monomer (b1) by means of the copolymer (P2). An aqueous solution of gluconolactonic acid is then added with stirring and at a temperature of 25° C.

Finally, heating is carried out with stirring at a temperature of 70° C. for 2 hours. The medium is then cooled and the polymer (P1) according to the invention is obtained. The reactants and the proportions (g) used and also the properties of the polymers according to the invention obtained are presented in Table 1.

TABLE 1

| Polymer (P1) | P1-1 | P1-2 | P1-3 | P1-4 | P1-5 | P1-6 | P1-7 | P1-8 | P1-9 |
|---|---|---|---|---|---|---|---|---|---|
| Polymer (P2-1) | 107.15 | 107.15 | 107.15 | 142.86 | 0 | 0 | 0 | 108.2 | 108.2 |
| Polymer (P2-2) | 0 | 0 | 0 | 0 | 145.7 | 126.65 | 160.39 | 0 | 0 |
| Water | 192.85 | 192.85 | 192.85 | 217.14 | 254.3 | 221.05 | 219.61 | 167.8 | 167.8 |
| Disponil G625 | 3.06 | 3.06 | 3.06 | 4.09 | 4.1 | 3.56 | 3.92 | 3.12 | 0 |
| 95% AMP | 6.2 | 6.23 | 6.29 | 8.2 | 10.06 | 8.74 | 12.23 | 6.225 | 6.216 |
| Degree of neutralization of | 47.40 | 47.63 | 48.09 | 47.02 | 56.56 | 56.53 | 62.46 | 47.13 | 47.06 |
| the acid groups of (P2) (%) | | | | | | | | | |
| pH after neutralization of (P2) | 6 | 6.1 | 6 | 6.3 | 7.7 | 7.7 | 7.8 | 6 | 6.1 |
| Styrene (b1) | 61.88 | 106.08 | 165 | 38.52 | 40 | 80 | 80 | 61.88 | 61.88 |
| AZDN (b2) | 0.618 | 1.06 | 1.65 | 0.385 | 0.4 | 0.8 | 0.8 | 0.618 | 0.618 |
| Gluconolactonic acid | 4.87 | 4.87 | 4.87 | 6.61 | 8.99 | 7.99 | 9.38 | 4.87 | 4.87 |
| Water | 92.5 | 92.5 | 92.5 | 33.94 | 46.2 | 41.06 | 48.2 | 92.5 | 92.5 |
| Polymerization temperature | 78-82 | 78-82 | 78-82 | 78-82 | 78-82 | 78-82 | 78-82 | 80-85 | 80-85 |
| (° C.) | | | | | | | | | |
| Final solids content (% by | 23.7 | 31.4 | 39.2 | 21.8 | 21 | 28.7 | 30.1 | 25.1 | 24.5 |
| weight) | | | | | | | | | |
| Diameter of the particles (nm) | 151 | 384 | 387 | 183 | 125 | 255 | 185.3 | 155.7 | 138.8 |

### Example 2: Method for the Preparation of Copolymers (P1) According to the Invention

A mixture of water, of copolymer (P2) of HASE type, of a base (95% by weight monoisopropylamine) and, if appropriate, of an amphiphilic compound (Disponil G625, Cognis) is prepared in a stirred reactor at a temperature of 25° C. The copolymer (P2) of HASE type used is the copolymer (P2-1).

The monomers (b1) and then the radical-generating compound (b2) are added with stirring at a temperature of 25° C. in order to prepare an emulsion of monomer (b1) by means of the copolymer (P2).

An aqueous solution of gluconolactonic acid is then added with stirring and at a temperature of 25° C.

Finally, heating is carried out with stirring at a temperature of 70° C. for 2 hours. The medium is then cooled and the copolymer (P1) according to the invention is obtained.

The reactants and the proportions used and also the properties of the copolymers according to the invention are presented in Table 2.

TABLE 2

| Polymer (P1) | P1-10 | P1-11 | P1-12 | P1-13 |
|---|---|---|---|---|
| Polymer (P2-1) | 108.2 | 108.2 | 108.2 | 108.2 |
| Water | 167.8 | 167.8 | 167.8 | 167.8 |
| Disponil G625 | 0 | 3.17 | 3.21 | 3.19 |
| 95% AMP | 6.216 | 6.164 | 6.177 | 6.219 |
| Dcgrcc of neutralization of | 47.06 | 46.67 | 46.77 | 47.08 |
| the acid groups of (P2) (%) | | | | |
| pH | 6.15 | 6 | 6.1 | 6 |
| Styrene (b1) | 31 | 31 | 37.2 | 24.8 |
| n-Butyl acrylate (b1) | 31 | 31 | 24.8 | 37.2 |
| AZDN (b2) | 0.62 | 0.62 | 0.62 | 0.62 |
| Gluconolactonic acid | 4.87 | 4.87 | 4.87 | 4.87 |
| Water | 92.5 | 92.5 | 90 | 90 |
| Polymerization temperature (° C.) | 80-85 | 80-85 | 80-85 | 80-85 |
| Final solids content (% by weight) | 24.8 | 24.6 | 24.8 | 25.2 |
| Diameter of the particles (nm) | 140.3 | 135.9 | 138.3 | 149.8 |

1. A method for the preparation in water of a polymer (P1) comprising:
(a) preparing, at a temperature of less than 40° C., a mixture comprising water and at least one copolymer (P2) of HASE type completely or partially neutralized by a base,
(b) adding, with stirring and at a temperature of less than 40° C.:
(b1) at least one monomer comprising at least one polymerizable olefinic unsaturation, and
(b2) at least one radical-generating compound, and
(c) polymerizing, with stirring, the monomer (b1) by heating at a temperature of greater than 50° C.

2. The method according to claim 1, wherein:
droplets of monomer (b1) are dispersed by the copolymer (P2) of HASE type, or
droplets of polymer (P1) are dispersed by means of the copolymer (P2) of HASE type, or
an emulsion of monomer (b1) or of polymer (P1) prepared by the copolymer (P2) of HASE type has a solids content ranging from 10% by weight to 50% by weight of emulsion.

3. The method according to claim 1, wherein:
the temperature of (a) and (b), which is identical or different, is less than 35° C., or
the temperature of (c) is greater than 60° C.

4. The method according to claim 1, wherein the polymer (P2) of HASE type is obtained by a polymerization reaction:
(a1) of at least one anionic monomer comprising at least one polymerizable olefinic unsaturation,
(a2) of at least one ester of a compound derived from an acid selected from the group consisting of acrylic acid, methacrylic acid, itaconic acid and maleic acid,
(a3) of at least one compound of formula (I):
R¹-(EO)ₘ—(PO)ₙ—R² (I)
wherein:
m and n, which are identical or different, independently represent 0 or an integer or decimal number of less than 150, wherein at least one of m and n is other than 0,
each EO independently represents a CH₂CH₂O group,
each PO independently represents a group selected from the group consisting of CH(CH₃)CH₂O and CH₂CH(CH₃)O,
R¹ represents a linear or branched C₆-C₄₀ alkyl group, and
R² represents a group comprising at least one polymerizable olefinic unsaturation,
optionally (a4) of at least one compound selected from the group consisting of 2-acrylamido-2-methylpropanesulfonic acid, ethoxymethacrylate sulfonic acid, sodium methallylsulfonate, styrenesulfonate and salts thereof, and
optionally (a5) of at least one cross-linking monomer or of at least one monomer comprising at least two olefinic unsaturations.

5. The method according to claim 1, wherein:
the radical-generating compound (b2) and the monomer (b1) are added in the form of a mixture or
the radical-generating compound (b2) and the monomer (b1) are added separately or successively.

6. The method according to claim 1, wherein the monomer (b1) is a non-ionic monomer.

7. The method according to claim 1, wherein the radical-generating compound (b2) is at least one compound selected from the group consisting of an azo compound, a peroxide compound, an alkali metal persulfate, and a persulfate combined with a ferrous ion, with a sulfite ion or with a bisulfite ion, optionally combined with one or more controlled radical polymerization transfer agent.

8. The method according to claim 1, wherein (b) further comprises adding at least one other monomer.

9. The method according to claim 1, wherein an amount of surface-active compound is less than 5% by weight of monomer.

10. A polymer (P1) obtained by the method according to claim 1.

11. A composite comprising at least one polymer (P1) obtained by the method according to claim 1, surrounded by a copolymer (P2) of HASE type.

12. The method according to claim 6, wherein the non-ionic monomer comprises at least one polymerizable olefinic unsaturation.

13. The method according to claim 6, wherein the non-ionic monomer comprises at least one selected from the group consisting of styrene, vinylcaprolactam, methyl acrylate, ethyl acrylate, propyl acrylate, isobutyl acrylate, n-butyl acrylate methyl methacrylate, ethyl methacrylate, propyl methacrylate, isobutyl methacrylate, n-butyl methacrylate, benzyl acrylate, phenoxyethyl acrylate, phenyl methacrylate, benzyl methacrylate, phenoxyethyl methacrylate.

14. The method according to claim 8, wherein the other monomer is at least one selected from the group consisting of:
(b3) a non-ionic hydrophilic monomer,
(b4) an anionic monomer,
(b5) at least one compound selected from the group consisting of 2-acrylamido-2-methylpropanesulfonic acid, ethoxymethacrylate sulfonic acid, sodium methallylsulfonate, styrenesulfonate, and salts thereof, and
(b6) a monomer comprising at least two olefinic unsaturations.
